(19) United States
(12) Patent Application Publication
(10) Pub. No.: US 2012/0214118 A1
(43) Pub. Date: Aug. 23, 2012

(54) ROTARY HEARTH FURNACE

(75) Inventors: Masataka Tateishi, Kobe-shi (JP); Hirofumi Tsutsumi, Kobe-shi (JP); Yutaka Miyakawa, Kobe-shi (JP); Tadashi Yaso, Kobe-shi (JP)

(73) Assignee: Kabushiki Kaisha Kobe Seiko Sho (Kobe Steel, Ltd.), Kobe-shi (JP)

(21) Appl. No.: 13/505,293

(22) PCT Filed: Nov. 29, 2010
(86) PCT No.: PCT/JP10/71300

§ 371 Date: May 1, 2012

(30) Foreign Application Priority Data
Nov. 30, 2009 (JP) 2009-271918

(51) Int. Cl. F27B 9/16; F27D 19/00; F27B 5/16

(52) U.S. Cl. 432/49; 432/138; 432/195; 432/200

(57) ABSTRACT

Provided is a rotary hearth furnace which can stir exhaust gas within a furnace, to efficiently burn flammable gas within the exhaust gas and to efficiently heat an object to be heated, and which can contribute to reduction of specific energy consumption and improvement of productivity. A rotary hearth furnace (1) has therein a series of zone spaces (3) which are divided by vertical walls (2) hanging from a ceiling (1c). Among the zone spaces (3), the zone space to which an exhaust gas duct (4) is attached is constructed as an exhaust zone (3a). An oxygen-containing gas supply unit (5) is provided in the vicinity of the lower edge of the vertical wall (2) which divides the exhaust zone (3a) from the other zone spaces (3). Further, the exhaust gas duct (4) is disposed on the outer periphery side or the inner periphery side from the center of the width of the zone space (3).

### TECHNICAL FIELD

The present invention relates to rotary hearth furnaces in which dust generated in steel mills or the like, iron ore, etc., are used as raw materials. More specifically, the present invention relates to a rotary hearth furnace capable of efficiently burning combustible gas generated from agglomerates with a carbonaceous material (hereinafter referred to as an object to be heated) supplied to the furnace and fuel fed into the furnace.

### BACKGROUND ART

Recently, a production method using a rotary hearth furnace has been attracting attention. In this production method, reduced iron is produced by supplying an object to be heated to the furnace and heating the object. The object to be heated is obtained by mixing iron ore, steel mill dust, etc., with a powdered carbonaceous material and agglomerating the mixture. During the reduction process, zinc and lead contained in the heated object are reduced and vaporized so that zinc, lead, etc., are separated and collected. The object is heated to a high temperature, such as 1,200° C. to 1,400° C., in the furnace. As a result, heating gas, such as CO, is generated from the heated object by the reduction reaction.

Various proposals have been made with regard to the rotary hearth furnace. Among such various proposals, a rotary hearth furnace and an operation method thereof described in Patent Literature 1 are an effective one. According to this rotary hearth furnace and the operation method thereof, the combustible gas generated in the furnace can be completely burned and used for the heating and reducing process without impeding, for example, the production of reduced iron. As a result, the fuel consumption can be reduced.

However, according to this proposal, a compartment that projects upward is provided to collect the exhaust gas generated in the rotary hearth furnace, and an exhaust duct is attached to a compartment defining portion (wall surface) of the compartment. The compartment is divided from the inside of the furnace by a constricted portion. An oxygen-containing-gas injection nozzle, through which oxygen-containing gas is injected into the furnace, is disposed at or near the constricted portion. Therefore, combustion of the combustible gas contained in the exhaust gas occurs in an area downstream of the oxygen-containing-gas injection nozzle, that is, in a compartment having a smaller capacity than that of the inside of the furnace.

In this structure, an amount of oxygen-containing gas that is injected is necessarily small relative to the amount of flow of the exhaust gas. Therefore, it takes a long time to burn the combustible gas. In addition, since the combustion heat is generated at a position separated from the inside of the main body of the rotary hearth furnace, the energy cannot always be effectively utilized in the furnace. Furthermore, since the constricted portion is provided, the space through which the radiant energy passes is small. There is a possibility that this will adversely affect the effective use of the radiant energy, in which case the radiant energy cannot be supplied to the object to be heated.

### CITATION LIST

### Patent Literature

PTL 1: Japanese Unexamined Patent Application Publication No. 2007-147261

### SUMMARY OF INVENTION

### Technical Problem

The present invention has been made in view of the above-described situation. An object of the present invention is to provide a rotary hearth furnace capable of contributing to reducing the energy consumption rate and increasing the productivity by efficiently burning combustible gas contained in the exhaust gas and efficiently heating an object to be heated.

### Solution to Problem

According to the present invention, a rotary hearth furnace has a hollow annular shape, and a plurality of zone spaces are arranged in the rotary hearth furnace. The zone spaces are continuous to each other and divided from each other by a plurality of vertical walls that hang from a ceiling. One of the zone spaces to which an exhaust gas duct is attached is configured as an exhaust zone. An oxygen-containing gas supply unit is disposed near a bottom edge of at least one of the vertical walls located at the ends of the exhaust zone in a circumferential direction. An end portion of the exhaust gas duct is attached to the exhaust zone in a manner such that the center of the end portion of the exhaust gas duct is disposed at a position shifted toward an outer peripheral side or an inner peripheral side from a furnace width center of the exhaust zone.

The oxygen-containing gas supply unit is preferably disposed at a position shifted toward the outer peripheral side or the inner peripheral side from a furnace width center of the zone spaces, the side at which the oxygen-containing gas supply unit is disposed being the same as the side at which the exhaust gas duct is attached.

Preferably, of the vertical walls located at the ends of the exhaust zone in the circumferential direction, the oxygen-containing gas supply unit is disposed near the bottom edge of the vertical wall at the end at which a flow ratio of the exhaust gas in the furnace is low.

Preferably, a thermometer is disposed at each of a position upstream of the oxygen-containing gas supply unit in a direction of flow of the exhaust gas and the end portion of the exhaust gas duct, and an amount of oxygen-containing gas supplied from the oxygen-containing gas supply unit is adjusted on the basis of temperatures measured by the thermometers.

### Advantageous Effects of Invention

In the rotary hearth furnace according to the present invention, the center of the end portion of the exhaust gas duct is disposed at a position shifted toward the outer peripheral side or the inner peripheral side from the furnace width center of the exhaust zone. Accordingly, the flow of the exhaust gas in the furnace can be shifted toward the outer peripheral side or the inner peripheral side. Therefore, the exhaust gas is stirred in the furnace, and the combustion reaction between the combustible gas and the oxygen gas contained in the exhaust gas can be accelerated.

The oxygen-containing gas supply unit is disposed near the bottom edge of one of the vertical walls that divide the exhaust zone from other zone spaces. Preferably, the oxygen-containing gas supply unit is disposed near the hearth. In such a case, the stirring effect can be increased and the time in which the oxygen-containing gas stays in the exhaust zone can be maximized. Accordingly, combustion of the combustible gas contained in the exhaust gas can be further accelerated.

In addition, when the oxygen-containing gas supply unit is provided at the same side as the side at which the exhaust gas duct is attached, the stirring effect can be further increased by the oxygen-containing gas supplied from the oxygen-containing gas supply unit. Accordingly, the combustion efficiency can be further increased.

Of the vertical walls located at the ends of the exhaust zone in the circumferential direction, the oxygen-containing gas supply unit may be disposed near the bottom edge of the vertical wall at the end at which the flow ratio of the exhaust gas in the furnace is low. In this case, the uniform mixing time of the oxygen-containing gas can be reduced and the combustion can be reliably accelerated. When the oxygen-containing gas supply unit is disposed at a position near the rotary hearth, combustion is further accelerated, which contributes to improving the heat transfer to the object to be heated.

In addition, when a thermometer is disposed at each of an entrance section and an exit section of the exhaust zone, the amount of oxygen-containing gas supplied from the oxygen-containing gas supply unit can be adjusted. Accordingly, the amount of oxygen-containing gas that is unnecessarily supplied to the furnace can be reduced. If the amount of supply of the oxygen-containing gas is small, combustion will be insufficient and the temperature will be reduced. However, according to the above-described structure, the amount of supply of the oxygen-containing gas can be optimized and the combustion efficiency can be increased.

When the thermometer is disposed at the entrance section of the exhaust zone, the amount of oxygen-containing gas supplied to the exhaust gas upstream zone can be appropriately adjusted.

### BRIEF DESCRIPTION OF DRAWINGS

FIG. 1 is a schematic perspective view of a rotary hearth furnace according to an embodiment the present invention.

FIG. 2 is a horizontal sectional view of the rotary hearth furnace according to the embodiment, taken at the height where vertical walls are disposed.

FIG. 3 is a vertical sectional view of an area around an exhaust zone in the rotary hearth furnace according to another embodiment of the present invention.

FIG. 4 illustrates the flow of gas in the area around the exhaust zone in the rotary hearth furnace, where part (a) is a schematic diagram illustrating the flow of gas according to another embodiment of the present invention and part (b) is a schematic diagram illustrating the flow of gas according to the related art in which an exhaust gas duct is located at a furnace width center.

FIG. 5 is a vertical sectional view of the area around the exhaust zone in the rotary hearth furnace according to an example, taken at a position near an outer peripheral wall.

FIG. 6 is a vertical sectional view of the area around the exhaust zone in the rotary hearth furnace according to the example, taken at a position near an inner peripheral wall.

FIG. 7 is a graph of the temperature at a position near the rotary hearth and the temperature of the exhaust gas at a position near an entrance of the exhaust gas duct, the graph illustrating the result of the example.

### DESCRIPTION OF EMBODIMENTS

The present invention will now be described in more detail with reference to embodiments illustrated in the accompanying drawings.

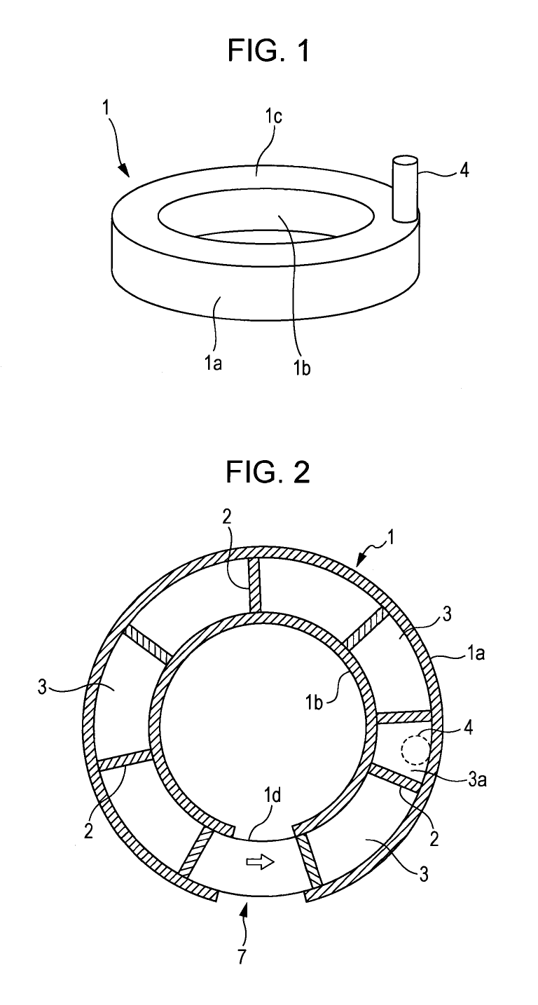

For example, as illustrated in FIGS. 1 to 3, a rotary hearth furnace 1 according to the present invention includes an outer peripheral wall 1a formed in an annular shape; an inner peripheral wall 1b formed in an annular shape having a slightly smaller radius of curvature than that of the outer peripheral wall 1a; an annular plate-shaped roof 1c disposed at the top so as to cover the space between the outer peripheral wall 1a and the inner peripheral wall 1b; and an annular plate-shaped rotary hearth id disposed at the bottom of the space between the outer peripheral wall 1a and the inner peripheral wall 1b. The rotary hearth furnace 1 is formed in a hollow annular shape having a substantially rectangular vertical cross section. The outer peripheral wall 1a, the inner peripheral wall 1b, and the roof 1c, in particular, of the rotary hearth furnace 1 are formed of a heat-insulating refractory material.

A plurality of vertical walls 2 hang from the bottom surface of the annular plate-shaped roof 1c, that is, from the ceiling of the rotary hearth furnace 1. The vertical walls 2 extend perpendicular to the circumferential direction of the rotary hearth furnace 1, and are spaced from each other by predetermined intervals. The vertical walls 2 divide the inside of the rotary hearth furnace 1 into a plurality of zone spaces 3 that are continuous to each other.

An exhaust gas duct 4 is attached to the ceiling of one of the zone spaces 3. The zone space 3 to which the exhaust gas duct 4 is attached is hereinafter referred to as an exhaust zone 3a. An end portion of the exhaust gas duct 4 is attached to the exhaust zone 3a. The end portion of the exhaust gas duct 4 that is attached to the exhaust zone 3a is hereinafter referred to also as an attachment portion. An oxygen-containing gas supply unit 5 is disposed near the bottom edge of one of the vertical walls 2 that divide the exhaust zone 3a from the other zone spaces 3 that are adjacent to the exhaust zone 3a. The exhaust gas duct 4 is attached to the ceiling of the exhaust zone 3a so that the center of the attachment portion is shifted toward the outer peripheral wall 1a from a furnace width center (center in the radial direction) of the zone spaces 3 that are continuous to each other, that is, from a furnace width center of the exhaust zone 3a.

The rotary hearth id is driven by a driving device (not shown) so as to rotate in, for example, the direction shown by the white arrow (leftward) in FIG. 2 along a rail (not shown) installed on the floor of the space between the outer peripheral wall 1a and the inner peripheral wall 1b. The rotary hearth 1d includes a furnace frame assembled in an annular shape and a hearth heat insulator that is disposed on the furnace frame and has a top surface covered with a refractory material.

An object to be heated (not shown) is supplied onto the rotary hearth 1d through a charging hole 7. The object to be heated is obtained by mixing a raw material containing zinc, lead, etc., such as iron ore or steel mill dust, with a powdered carbonaceous material and agglomerating the mixture. The rotary hearth 1d on which the object to be heated is placed is rotated in the rotary hearth furnace 1, so that the object is heated to a high temperature of 1,200° C. to 1,400° C. by burners 8 in the furnace. The exhaust gas is discharged through the exhaust gas duct 4. The exhaust gas is appropriately treated in the next step. Although FIG. 2 illustrates the embodiment in which the rotary hearth 1d rotates leftward, the rotary hearth 1d may, of course, rotate rightward instead.

As described above, the exhaust gas duct 4 is attached to the ceiling of the exhaust zone 3a so that the center of the attachment portion is shifted toward the outer peripheral wall 1a from the furnace width center of the exhaust zone 3a. Since the exhaust gas duct 4 is arranged in this manner, the flow velocity of the exhaust gas that flows in the rotary hearth furnace 1 is high in the area near the outer peripheral wall 1a, and low in the area near the inner peripheral wall 1b. Therefore, the exhaust gas is stirred in the furnace, and mixing of the combustible gas and the oxygen gas is accelerated.

The exhaust gas duct 4 may instead be located at a position shifted toward the inner peripheral wall 1b from the furnace width center of the exhaust zone 3a. In the case where the exhaust gas duct 4 is located at a position shifted toward the inner peripheral wall 1b from the furnace width center of the exhaust zone 3a, the flow velocity of the exhaust gas that flows in the rotary hearth furnace 1 is high in the area near the inner peripheral wall 1b, and low in the area near the outer peripheral wall 1a. Therefore, the exhaust gas is stirred in the furnace, and mixing of the combustible gas and the oxygen gas is accelerated.

Although the exhaust gas duct 4 is attached to the ceiling of the exhaust zone 3a in the present embodiment, the exhaust gas duct 4 may instead be attached to the outer peripheral wall 1a or the inner peripheral wall 1b of the exhaust zone 3a. In the case where, for example, the exhaust gas duct 4 is attached to the outer peripheral wall la, the center of the attachment portion is, of course, at a position shifted toward the outer peripheral wall 1a from the furnace width center of the exhaust zone 3a.

The bottom edge of each vertical wall 2 may be formed such that the end adjacent to the outer peripheral wall 1a is higher than the end adjacent to the inner peripheral wall 1b. In other words, each vertical wall 2 may be formed such that the distance from the rotary hearth 1d to the bottom edge of the vertical wall 2 is long at the end adjacent to the outer peripheral wall 1a and short at the end adjacent to the inner peripheral wall 1b. For example, the bottom edge of the vertical wall 2 may be inclined or formed stepwise so that the bottom edge of the vertical wall 2 at the end adjacent to the outer peripheral wall 1a is higher than that at the end adjacent to the inner peripheral wall lb. Accordingly, the flow velocity of the exhaust gas that flows in the rotary hearth furnace 1 can be made high in the area near the outer peripheral wall 1a, and low in the area near the inner peripheral wall 1b. Therefore, the exhaust gas is stirred in the furnace, and mixing of the combustible gas and the oxygen gas contained in the exhaust gas can be further accelerated.

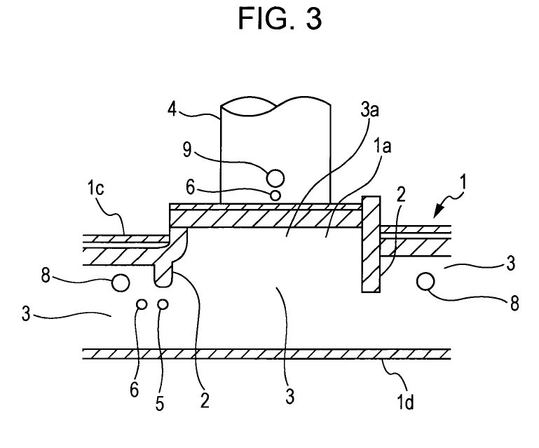

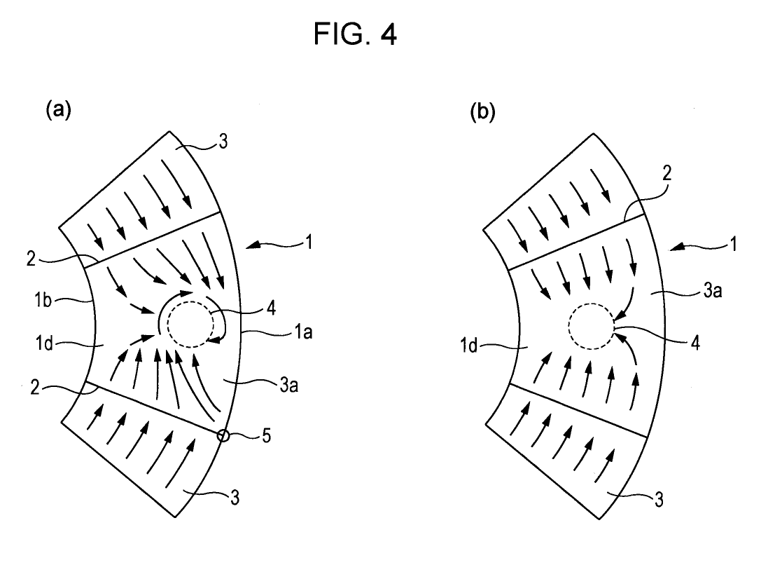

As illustrated in FIG. 3, the ceiling of the exhaust zone 3a may be positioned higher than the ceilings of the other zone spaces 3. In this case, exhaustion through the exhaust gas duct 4 and combustion of the combustible gas in the exhaust gas can be further accelerated. In the embodiment illustrated in FIG. 3, the ceiling of the exhaust zone 3a is higher, although slightly, than the ceilings of the other zone spaces 3.

Referring to FIGS. 1 and 2, of the zone spaces 3 that are continuous to each other, the exhaust zone 3a is provided at the upstream side in the moving direction of the rotary hearth 1d. When the exhaust zone 3a is provided at the upstream side in the moving direction of the rotary hearth 1d, mixing of the combustible gas and the oxygen gas contained in the exhaust gas can be accelerated. In the furnace, the flow ratio of the exhaust gas in an area upstream of the exhaust zone 3a in the moving direction of the rotary hearth 1d is lower than that in an area downstream of the exhaust zone 3a.

The oxygen-containing gas supply unit 5 is provided on, for example, the outer peripheral wall 1a at a position near the bottom edge of one of the vertical walls 2. In particular, the oxygen-containing gas supply unit 5 is preferably provided near the bottom edge of the vertical wall 2 that is provided at the upstream end of the exhaust zone 3a in the moving direction of the rotary hearth 1d. In this specification, the position near the bottom edge of the vertical wall 2 basically means the position in an area around the bottom edge of the vertical wall 2. The oxygen-containing gas supply unit 5 may be disposed at any position as long as the oxygen-containing gas supply unit 5 is in the area around the bottom edge of the vertical wall 2. The oxygen-containing gas supply unit 5 is preferably positioned at a height between the bottom edge of the vertical wall 2 and the top surface of the object to be heated on the rotary hearth 1d. More preferably, the oxygen-containing gas supply unit 5 is positioned near the object to be heated and such that at least a part of the oxygen-containing gas supply unit 5 is directly below the vertical wall 2 within the thickness of the vertical wall 2. Still more preferably, the oxygen-containing gas supply unit 5 is positioned such that the entire width of the oxygen-containing gas supply unit 5 is positioned directly below the vertical wall 2 within the thickness thereof. Most preferably, the center of the oxygen-containing gas supply unit 5 is positioned directly below the centerline of the vertical wall 2.

A thermometer 6, such as a thermocouple, is provided at each of a position upstream of the oxygen-containing gas supply unit 5 in the direction of flow of the exhaust gas (near the entrance side of the exhaust zone 3a) and a position near the attachment portion of the exhaust gas duct 4 (near the exit side of the exhaust zone 3a). The temperature at the position upstream of the oxygen-containing gas supply unit 5 is measured by the corresponding thermometer 6, so that the amount of oxygen-containing gas that is supplied can be appropriately adjusted. In addition, the temperature at the attachment portion of the exhaust gas duct 4 is measured, so that the combustion condition of the exhaust gas in the furnace can be recognized. The thus-obtained information is used to adjust the amount of oxygen-containing gas supplied from the oxygen-containing gas supply unit 5. The thermometer 6 disposed at the position upstream of the oxygen-containing gas supply unit 5 in the direction of flow of the exhaust gas may be located at any position as long as the temperature of the exhaust gas can be measured immediately before the exhaust gas reaches the oxygen-containing gas supply unit 5. However, the temperature cannot be accurately measured if the thermometer 6 is too close or far from the oxygen-containing gas supply unit 5. Most preferably, the thermometer 6 is located at the same height as that of the lower edge of the corresponding vertical wall 2.

In the case where the exhaust gas duct 4 is attached at a position shifted toward the outer peripheral wall 1a from the furnace width center of the exhaust zone 3a, preferably, the oxygen-containing gas supply unit 5 is also disposed at a position shifted toward the outer peripheral wall 1a from the furnace width center of the exhaust zone 3a. With this arrangement of the oxygen-containing gas supply unit 5, the stirring effect can be increased by the oxygen-containing gas supplied from the oxygen-containing gas supply unit 5. In the case where the oxygen-containing gas supply unit 5 is provided on the outer peripheral wall 1a, the oxygen-containing gas supply unit 5 is, of course, located at a position shifted toward the outer peripheral wall 1a from the furnace width center of the exhaust zone 3a.

The stirring effect caused when the oxygen-containing gas is supplied from the oxygen-containing gas supply unit 5 in the embodiment illustrated in FIG. 3 will now be described with reference to FIG. 4. FIG. 4 schematically illustrates the flow of gas in the area around the exhaust zone 3a in the rotary hearth furnace 1 viewed from the side where the exhaust gas duct 4 is disposed. FIG. 4(a) is a schematic diagram illustrating the flow of gas (in the horizontal direction) in the rotary hearth furnace 1 when the oxygen-containing gas is supplied from the oxygen-containing gas supply unit 5 in the embodiment illustrated in FIG. 3. FIG. 4(b) is a schematic diagram illustrating the flow of gas (in the horizontal direction) in the rotary hearth furnace 1 according to the related art in which the center of the exhaust gas duct 4 coincides with the furnace width center (no oxygen-containing gas is supplied).

In the example of the related art in which the center of the exhaust gas duct 4 coincides with the furnace width center, as illustrated in FIG. 4(b), the exhaust gas from the upstream side in the moving direction of the rotary hearth 1d (from the entrance side of the exhaust zone 3a) and the exhaust gas from the downstream side in the moving direction of the rotary hearth 1d (from the exit side of the exhaust zone 3a) encounter each other in the central area of the exhaust zone 3a, and are then discharged through the exhaust gas duct 4.

In contrast, in the embodiment of the present invention in which the exhaust gas duct 4 is shifted toward the outer peripheral wall 1a from the furnace width center, the gas flow velocity in the area near the outer peripheral wall 1a differs from the gas flow velocity in the area near the inner peripheral wall 1b. Therefore, the stirring effect is increased, and the combustion is accelerated. As illustrated in FIG. 4(a), a vortex-like flow is generated over the entire area of the exhaust zone 3a. Accordingly, the stirring effect is increased and the combustion is accelerated with the effective use of the capacity of the exhaust zone 3a. In addition, since the oxygen-containing gas is supplied from the oxygen-containing gas supply unit 5 in FIG. 4(a), the gas flow velocity is higher than that at the corresponding position in FIG. 4(b). Accordingly, the effect of stirring the gas flow is further increased. Therefore, mixing of the combustible gas and the oxygen gas in the exhaust gas in the exhaust zone 3a is accelerated, so that the combustion is accelerated.

In the case where the exhaust gas duct 4 is disposed at a position shifted toward the inner peripheral wall 1b from the furnace width center, preferably, the oxygen-containing gas supply unit 5 is also disposed at a position shifted toward the inner peripheral wall 1b from the furnace width center of the zone spaces 3 that are continuous to each other. With this arrangement of the oxygen-containing gas supply unit 5, the stirring effect can be increased by the oxygen-containing gas supplied from the oxygen-containing gas supply unit 5.

A cooling-air supply port 9 is formed in the exhaust gas duct 4 at a position near the attachment portion. Since the cooling-air supply port 9 is formed in the exhaust gas duct 4 at a position near the attachment portion, combustion of the exhaust gas in the exhaust gas duct 4 can be prevented. As a result, deterioration of the refractory material of the duct due to the combustion can be prevented.

### Example

The present invention will now be described in more detail with reference to an example. However, the present invention is not limited to the following example. The present invention may be carried out with modifications as appropriate within the gist of the present invention, and such modifications are included in the technical scope of the present invention.

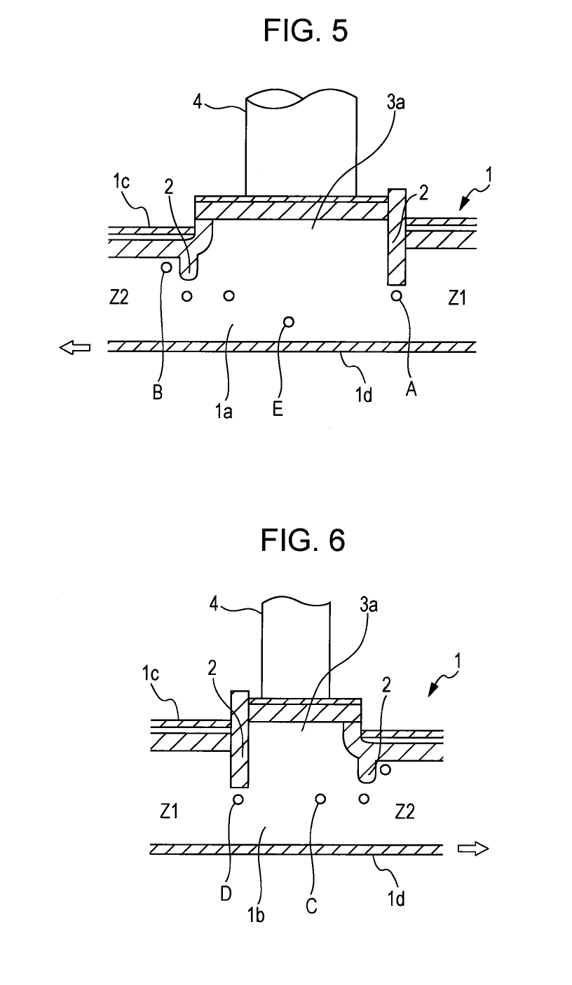

The example of the present invention will now be described. As illustrated in FIGS. 5 and 6, in this example, four oxygen-containing gas supply units (blowing nozzles) were provided at each of the other outer peripheral wall 1a and the inner peripheral wall 1b. Accordingly, eight oxygen-containing gas supply units were provided in total. One of these blowing nozzles was selected, and the opening degree thereof was set to 10 (fully opened). The opening degree of all of the other blowing nozzles was set to 1 (slightly opened) to protect the blowing nozzles from heat. In each case, the temperature at the position near the rotary hearth and the temperature of the exhaust gas at a position near the entrance of the exhaust gas duct 4 were measured. In this example, the exhaust gas duct 4 was attached to the ceiling of the exhaust zone 3a at a position shifted toward the outer peripheral wall 1a from the furnace width center. The rotating direction of the rotary hearth ld is shown by the white arrow.

Referring to FIGS. 5 and 6, in the spaces that are adjacent to the exhaust zone, the side at which the flow ratio of the exhaust gas is low is defined as a Z1 side, and the side at which the flow ratio is high is defined as a Z2 side. Referring to FIG. 5, at the outer peripheral wall 1a of the exhaust zone, the opening degree of two blowing nozzles A and B was set to 10 (fully opened). The blowing nozzle A was positioned at the Z1 side where the flow ratio of the exhaust gas in the furnace was low, and the blowing nozzle B was positioned at the Z2 side where the flow ratio of the exhaust gas in the furnace was high. Referring to FIG. 6, at the inner peripheral wall 1b of the exhaust zone 3a, the opening degree of two blowing nozzles C and D was set to 10 (fully opened). The blowing nozzle C was positioned at the Z2 side where the flow ratio of the exhaust gas in the furnace was high, and the blowing nozzle D was positioned at the Z1 side where the flow ratio of the exhaust gas in the furnace was low. Referring to FIG. 5, the temperature at the position near the rotary hearth 1d was measured by a thermometer E disposed at a position 130 mm above the rotary hearth 1d.

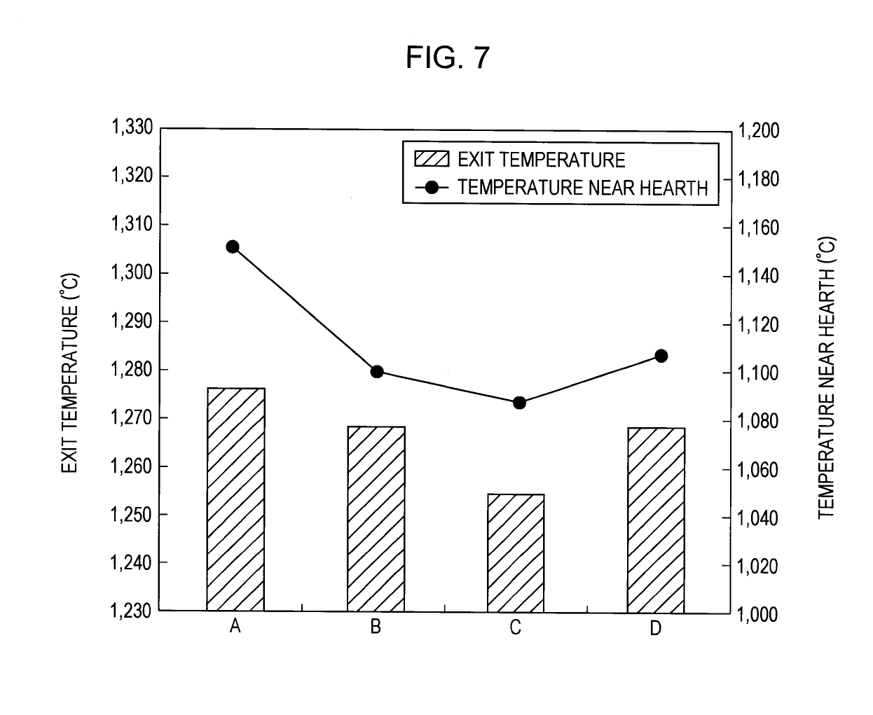

Referring to the test result illustrated in FIG. 7, when the blowing nozzle (A or B) at the outer peripheral wall 1a of the exhaust zone 3a illustrated in FIG. 5 was fully opened, the temperature at the position near the rotary hearth 1d and the temperature of the exhaust gas at the position near the entrance of the exhaust gas duct 4 were higher than those when the blowing nozzle (C or D) at the inner peripheral wall 1b of the exhaust zone 3a illustrated in FIG. 6 was fully opened. In addition, when the blowing nozzle (A or D) at the side where the flow ratio of the exhaust gas in the furnace was low was fully opened, the temperature at the position near the rotary hearth 1d and the temperature of the exhaust gas at the position near the entrance of the exhaust gas duct 4 were higher than those when the blowing nozzle (B or C) at the side where the flow ratio of the exhaust gas in the furnace was low was fully opened.

According to the above-described test result, as is clear from FIG. 7, the temperature at the position near the rotary hearth 1d and the temperature of the exhaust gas at the position near the entrance of the exhaust gas duct 4 are at a highest when the blowing nozzle A illustrated in FIG. 5, that is, the blowing nozzle A provided at the outer peripheral wall 1a of the exhaust zone 3a and at the side where the flow ratio of the exhaust gas is low, is fully opened. Accordingly, the combustible gas in the exhaust gas can be efficiently burned. Accordingly, the oxygen-containing gas supply unit (blowing nozzle) is most preferably provided at the outer peripheral wall 1a of the exhaust zone 3a and near the bottom edge of the vertical wall 2 at the side where the flow ratio of the exhaust gas in the furnace is low.

Although embodiments of the present invention are described above, the present invention is not limited to the above-described embodiments, and various modifications are possible within the scope as described in the claims. This application is based on Japanese Patent Application (Japanese Unexamined Patent Application Publication No. 2009-271918) filed Nov. 30, 2009, the contents of which are incorporated herein by reference.

### Reference Signs List

1 rotary hearth furnace

1a outer peripheral wall

1b inner peripheral wall

1c roof

1d rotary hearth

2 vertical wall

3 zone space

3a exhaust zone

4 exhaust gas duct

5 oxygen-containing gas supply unit

6 thermometer

7 charging hole

8 burner

9 cooling-air supply port

1. A rotary hearth furnace that has a hollow annular shape and in which a plurality of zone spaces are arranged, the zone spaces being continuous to each other and divided from each other by a plurality of vertical walls that hang from a ceiling,
wherein one of the zone spaces to which an exhaust gas duct is attached is configured as an exhaust zone,
wherein an oxygen-containing gas supply unit is disposed near a bottom edge of at least one of the vertical walls located at the ends of the exhaust zone in a circumferential direction, and
wherein an end portion of the exhaust gas duct is attached to the exhaust zone in a manner such that the center of the end portion of the exhaust gas duct is disposed at a position shifted toward an outer peripheral side or an inner peripheral side from a furnace width center of the exhaust zone.

2. The rotary hearth furnace according to claim 1, wherein the oxygen-containing gas supply unit is disposed at a position shifted toward the outer peripheral side or the inner peripheral side from a furnace width center of the zone spaces, the side at which the oxygen-containing gas supply unit is disposed being the same as the side at which the exhaust gas duct is attached.

3. The rotary hearth furnace according to claim 1, wherein, of the vertical walls located at the ends of the exhaust zone in the circumferential direction, the oxygen-containing gas supply unit is disposed near the bottom edge of the vertical wall at the end at which a flow ratio of exhaust gas in the furnace is low.

4. The rotary hearth furnace according to claim 1, wherein a thermometer is disposed at each of a position upstream of the oxygen-containing gas supply unit in a direction of flow of exhaust gas and the end portion of the exhaust gas duct, and wherein an amount of oxygen-containing gas supplied from the oxygen-containing gas supply unit is adjusted on the basis of temperatures measured by the thermometers.
